(19) United States
(12) Patent Application Publication
(10) Pub. No.: US 2015/0210890 A1
(43) Pub. Date: Jul. 30, 2015

(54) Polishing-Material Reclamation Method

(71) Applicant: KONICA MINOLTA, INC., Chiyoda-ku, Tokyo (JP)

(72) Inventors: Yuuki Nagai, Tachikawa-shi (JP); Akihiro Maezawa, Hino-shi (JP); Chie Inui, Hino-shi (JP)

(21) Appl. No.: 14/417,302

(22) PCT Filed: Jul. 24, 2013
(86) PCT No.: PCT/JP2013/070034

§ 371 Date: Jan. 26, 2015

(30) Foreign Application Priority Data
Jul. 25, 2012 (JP) 2012-164825

(51) Int. Cl. C09G 1/02; B03C 1/02

(52) U.S. Cl. CPC C09G 1/02; B03C 1/02; B03C 2201/18; B03C 2201/20

(57) ABSTRACT

Method to obtain a highly pure reclaimed polishing material from a polishing-material slurry including already used polishing material. A polishing is reclaimed from a polishing-material slurry by undergoing: recovering in step (A) a polishing-material slurry including already used polishing material; adding in step (B) an alkali earth metal-containing metal salt to the recovered polishing-material slurry to cause the polishing material to agglomerate, and the polishing material is separated from the mother liquor and concentrated; the polishing material, having had been separated and concentrated, is subjected in step (C) to solid-liquid separation, and recovered; and using in step (D) a magnetic filter to filter and remove metal particles included in the polishing-material slurry. Step (D) is performed at the same time as step (B) or step (C), or performed after either step (A), step (B), or step (C).

### FIELD OF THE INVENTION

The present invention relates to a method for regenerating an abrasive.

### BACKGROUND ART

As an abrasive for finely polishing an optical glass element, a glass substrate and a semiconductor device in a manufacture process, a rare-earth oxide material mainly composed of cerium oxide and further containing lanthanum oxide, neodymium oxide, praseodymium oxide, etc. has been used. In addition, diamond, iron oxide, aluminum oxide (also called alumina), zirconium oxide (also called zirconia), colloidal silica, etc. have been used as an abrasive.

Some of the main components of the abrasives are obtained from minerals that are not produced in Japan, and thus partially relies on imported materials. In addition, many of the main components of the abrasives are expensive. Hence, technical measures to reuse a resource(s) in an abrasive waste liquid containing a used abrasive are needed.

In various fields of industry, a conventional method for disposing a waste liquid that contains suspended particles normally includes aggregating and separating the suspended particles using a neutralizer, inorganic coagulant or polymeric coagulant, discharging a treated solution and disposing the aggregated and separated sludge by incineration or the like.

Components derived from the polished object, for example, debris of an optical glass, caused in large quantity in a polishing process are mixed in waste liquid including used abrasive. It is usually difficult to efficiently separate the abrasive from the components derived from the polished object in the waste liquid. Therefore a waste liquid is disposed after use at present, and there are problems concerning disposal cost.

Thus, recently it is important to establish a method for efficiently collecting and reusing a main component of an abrasive for recycling scarce elements.

As a method for collecting a colloidal silica-based abrasive, a method for collecting an abrasive by adding an alkali to waste liquid of an abrasive in the presence of a magnesium ion to adjust pH to 10 or higher and to cause aggregation (for example, Patent Document 1).

### PRIOR ART DOCUMENT

### Patent Document

Patent Document 1: Japanese Patent Application Laid-Open Publication No. 2000-254659

### SUMMARY OF THE INVENTION

### Problems to be Solved by the Invention

However, an abrasive-containing slurry including a used abrasive is sometimes contaminated with impurities, that is, particles of metal elements other than an abrasive component.

In the method of Patent Document 1, an abrasive is collected by separating the abrasive from components derived from a polished object. However, metal particles, which are contaminating impurities, are not removed.

As a method for removing particles that are impurities, removal using a ceramic filter, etc. with a mesh or the like is known. However, in the method for removing particles that are impurities using the ceramic filter, etc., mixed metal particles with a particle size larger than that of an abrasive particle is removed while particles with a size equal to or smaller than that of an abrasive particle is not removed sufficiently. This decreases purity of a regenerated abrasive.

An object of the present invention is to provide a method for regenerating an abrasive that enables obtainment of a regenerated abrasive with higher purity from a used abrasive-containing slurry.

### Means for Solving Problems

In order to solve the above problem, the invention according to claim 1 is a method for regenerating an abrasive from an abrasive-containing slurry including a used abrasive.

The method includes:

(A) collecting the abrasive-containing slurry including the used abrasive;

(B) separating the abrasive from a mother liquid and concentrating the abrasive by adding a metal salt including an alkali earth metal as an inorganic salt to the collected abrasive-containing slurry to aggregate the abrasive; and

(C) collecting the abrasive, which was separated and, concentrated, through solid-liquid separation,

(D) filtering metal particles that get mixed in with the abrasive-containing slurry using a magnetic filter to remove the particles.

The step (D) is conducted after any one of the steps (A) to (C) or simultaneously with the step (B) or (C). The abrasive is at least one selected from a group consisting of cerium oxide, diamond, boron nitride, silicon carbide, alumina, alumina-zirconia and zirconium oxide.

The invention according to claim 2 is the method of claim 1, wherein

the magnetic filter is constituted by a permanent magnet material or an electromagnet material.

The invention according to claim 3 is the method of claim 1 or 2, further including:

(E) adjusting sizes of particles of the collected abrasive.

The step (D) is conducted just before the step (E).

The invention according to claim 4 is the method of claim 3, further including:

(F) secondarily concentrating the collected abrasive through filtration, after the step (C) and before the step (E).

The invention according to claim 5 is the method of any one of claims 1 to 4, wherein

the metal salt including an alkali earth metal used in the step (B) is a magnesium salt.

The invention according to claim 6 is the method of any one of claims 1 to 5, wherein in the step (C), the collecting is conducted through separation by decantation utilizing spontaneous sedimentation.

### Effects of the Invention

By virtue of the above methods of the present invention, a regenerated abrasive with higher purity can be obtained from an abrasive-containing slurry including a used abrasive.

### BRIEF DESCRIPTION OF DRAWINGS

FIG. 1 This is a schematic diagram illustrating a flow chart of elemental steps of the method of the present invention for regenerating an abrasive.

### EMBODIMENTS FOR CARRYING OUT THE INVENTION

The present invention, and elements and embodiments thereof will now be described in detail. Ranges of values expressed with “(from) A to B” in the following description include the values A and B as the minimum and maximum values of the ranges.

Conventional abrasive, details of the method of the embodiment of the present invention for regenerating an abrasive and of techniques for the method will now be described.

[Abrasive]

Generally, fine particles of Bengala (α Fe₂O₃), cerium oxide, aluminum oxide, manganese oxide and/or zirconium oxide, or colloidal silica is dispersed as an abrasive in water or oil to form a slurry, and it is used for polishing optical glasses, semiconductor substrates and the like. The abrasive regeneration method of the present invention is applied to collecting an abrasive which is at least one selected from the group consisting of cerium oxide, diamond, boron nitride, silicon carbide, alumina, alumina-zirconia and zirconium oxide. These abrasives are applicable to Chemical Mechanical Polishing (CMP). CMP utilizes mechanical and chemical actions and achieves sufficient speed and highly fine flatness in polishing the surface of a semiconductor substrate or a glass.

The cerium oxide (such as the ones by C. I. Kasei Co., Ltd, Techno Rise Corporation and Wake Pure Chemical Industries, Ltd.) widely used as an abrasive is not pure cerium oxide but is so-called bastnaesite which is prepared by sintering a mineral ore rich in rare earth elements and crashing the mineral ore. In this cerium oxide, cerium oxide is present as a main component. In addition, rare earth elements such as lanthanum, neodymium, praseodymium and the like are also contained. Fluorides of them may be contained in addition to oxides of them. Although cerium oxide is used as an abrasive in the following explanation, it is one of examples and others can be used as the abrasive.

The composition and shape of the abrasive used in the present invention is not particularly limited. A commercially available abrasive can be used as the abrasive in the present invention. Preferably, the content of abrasive component is 50% by mass or more to achieve the effects of the present invention more sufficiently.

A flow chart of the method of an embodiment of the present invention for regenerating an abrasive will now be described.

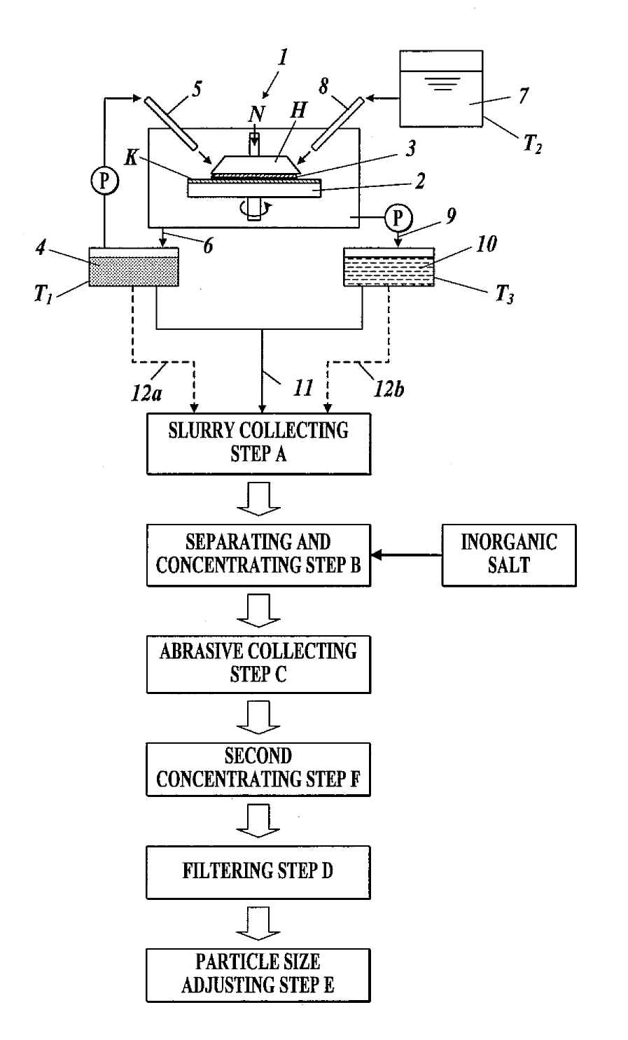

FIG. 1 is a schematic diagram illustrating a flow chart of elemental steps of the method of the present invention for regenerating an abrasive.

The present invention is a method for regenerating an abrasive as a regenerated abrasive from a used abrasive which is used in a polishing process before a slurry collecting step A in FIG. 1. Before explanation of the method for regenerating an abrasive, the polishing process by an abrasive will be explained.

[Polishing Process]

Taking polishing of a glass substrate as an example, a polishing process is normally composed of preparing an abrasive-containing slurry, polishing and washing of a polishing portion.

In a polishing process illustrated in FIG. 1, an abrader 1 includes an abrasive surface plate 2 on which an abrasive cloth K composed of a non-woven cloth, synthetic resin foam or synthetic leather is adhered. The abrasive surface plate 2 is rotatable. In polishing, the abrasive surface plate 2 is rotated while an object 3 to be polished which is mainly composed of silicon (e.g., optical glass, a glass substrate for data storage medium, a silicon wafer, etc.) is pushed against the abrasive surface plate 2 with a predetermined pressure force N by a holder H. Simultaneously, an abrasive liquid 4 (abrasive-containing slurry) which is prepared in advance is supplied through a slurry nozzle 5 using a pump P. The used abrasive liquid 4 (slurry containing a used abrasive) passes through a flow pass 6 and is then put and pooled in a slurry tank T₁. The abrasive liquid 4 is repeatedly circulated through the abrader 1 and the slurry tank

Washing water 7 for washing the abrader 1 is pooled in a washing water tank T₂. Washing water 7 is sprayed through a washing water-spraying nozzle e to a polishing portion, and then, as an abrasive-containing wash liquid 10 (slurry containing a used abrasive), passes through a flow pass 9 using a pump and is put and pooled in a wash liquid tank T₃. The wash liquid tank T₃ is used for pooling the wash liquid that was used in the washing (rinsing). The pooled liquid in the wash liquid tank T₃ is continuously stirred using a stirring blade to avoid sedimentation and aggregation.

The abrasive liquid 4 that is caused by polishing, pooled in the slurry tank T₁ and then repeatedly circulated and used and the wash liquid 10 that is pooled in the wash liquid tank T₃ both contain not only particles of abrasive but also a glass component, etc. removed from the polished object 3 which is polished.

Specific method in the polishing process will be explained.

### (1) Preparation of Abrasive-Containing Slurry

Powder of an abrasive is added in an amount of 1 to 40% by mass to a solvent such as water and then dispersed in the solvent to obtain an abrasive-containing slurry. This abrasive-containing slurry is circulated through an abrader 1 and used as illustrated in FIG. 1. The particles used as the abrasive have an average size ranging from several dozen nanometers to several micrometers.

It is preferable that aggregation of the abrasive particles is prevented by adding a dispersing agent and the like to the abrasive-containing slurry that is circulated and used, and that dispersing state is maintained by stirring using a stirrer or the like. In general, it is preferable that a tank used for pooling an abrasive-containing slurry is arranged next to the abrader 1, dispersing state is maintained using a stirrer or the like, and the abrasive-containing slurry is supplied to the abrader 1 and circulated through the abrader 1 using a supplying pump.

(2) Polishing

As illustrated in FIG. 1, the object 3 to be polished is brought into contact with the abrasive pad (abrasive cloth K). The glass substrate 3 and the abrasive pad K are moved relative to each other under pressure force while the abrasive-containing slurry is supplied to the contacting face.

(3) Washing

When the polishing is finished, a large quantity of the abrasive is present on the polished object 3 and the abrader 1. Thus, water or the like is supplied in place of the abrasive-containing slurry after the polishing to wash the abrasive to remove it from the polished object 3 and the abrader 1. Then, the washing water 10 which contains the abrasive is discharged to the outside 9 of the polishing system.

As a result of the washing, a certain amount of the abrasive is discharged to the outside 9 of the polishing system, and thus the amount of the abrasive in the polishing system is reduced. To make up for this reduction, a fresh abrasive-containing slurry is newly supplied to the slurry tank T₁. The addition may be conducted after every single polishing process or after every predetermined times of repeated polishing process. Preferably, the abrasive is in a well-dispersed state in the solvent when added.

[Used Abrasive-Containing Slurry]

In the present invention, the used abrasive-containing slurry is the abrasive-containing slurry pooled in the wash lizuid tank T₃ and the abrasive-containing slurry discharged to the outside of the system including the abrader 1, the slurry tank T₁ and the wash liquid tank T₃, and is categorized mainly into the following two types.

One is an abrasive-containing slurry which contains the washing water discharged in the washing process and is pooled in the wash liquid tank T₃ (a rinse slurry), and the other is an abrasive-containing slurry that was used and is pooled in the slurry tank T₁, and that is disposed after use for a certain number of times of polishing (a life-ended slurry).

The rinse slurry which contains the washing water is characterized by the following two features.

1) This slurry is discharged in the washing. Thus, this slurry contains a large amount of the washing water and the concentration of the abrasive in this slurry is drastically lower than that of the abrasive-containing slurry in the system in the polishing process.

2) The glass component which was present on the abrasive cloth K or the like is included in the rinse slurry as a result of the washing.

On the other hand, the life-ended slurry is characterized in that the concentration of the glass component is higher than that of a fresh abrasive-containing slurry.

[Method for Regenerating Abrasive]

The method for regenerating an abrasive according to the present invention, in which a high-purity abrasive is regenerated from an abrasive-containing slurry including a used abrasive, is composed of six steps, namely, the slurry collecting step A, the separating and concentrating step B, the abrasive collecting step C, the second concentrating step F, the filtering step D and the particle size adjusting step E, as explained in FIG. 1. Either or both of the second collecting step F and the particle size adjusting step E may be omitted in accordance with the kind, required concentration, purity, etc. of an abrasive to be reused as a regenerated abrasive.

(1: Slurry Collecting Step A)

The slurry collecting step A is a step in which the abrasive-containing slurry including a used slurry. The concentration of the abrasive in the collected abrasive-containing slurry is about 0.1 to 40% by mass.

The collected abrasive-containing slurry may be subjected to the separating and concentrating step B immediately after the collection or may be pooled to obtain a certain amount of the collected abrasive-containing slurry. In each case, it is preferable to continuously stir the collected abrasive-containing slurry to prevent aggregation of the particles and to maintain the stable dispersing state.

In the present invention, the two kinds of abrasive-containing slurries collected in the slurry collecting step A may be mixed with each other to prepare the mother liquid and then subjected to the separating and concentrating step B. Otherwise, the rinse slurry and the life-ended slurry collected in the slurry collecting step A may be separately subjected to the separating and concentrating step B as the mother liquids independent from each other.

(2: Separating and Concentrating Step B)

In the separating and concentrating step C, a metal salt including an alkali earth metal element is added as an inorganic salt to the collected abrasive-containing slurry to aggregate the abrasive. The abrasive is separated from the mother liquid and is concentrated. The collected abrasive-containing slurry which was used contains a glass component derived from the polished object. The concentration of the abrasive is decreased due to influx of the washing water. To reuse the collected abrasive for the polishing, the glass component and the like need to be separated, and the abrasive component needs to be concentrated.

Specifically, in the separating and concentrating step B, an alkali earth metal salt is added as an inorganic salt to the collected abrasive-containing slurry (mother liquid) which was collected in the slurry collecting step A while an pH adjusting agent is not added. The abrasive component is aggregated selectively while the non-abrasive component (glass component) is not aggregated. In this state, the abrasive is separated from the mother liquid and is concentrated. In this way, the abrasive component is aggregated selectively and then sedimentation occurs while most of the glass component remains in the supernatant. Thereby the abrasive component is separated. Thus, this step enables both of the separation of the abrasive component from the glass component and the concentration in the abrasive-containing slurry.

<Alkali Earth Metal Salt>

Examples of the alkali earth metal salt used in the present invention include calcium salts, strontium salts and barium salts. In addition, in a broad sense, elements of Group 2 of the periodic table is also defined as alkali earth metals. Thus, beryllium salts and magnesium salts are also regarded as the alkali earth metal salts in the present invention.

The alkali earth metal salt used in the present invention is preferably a halide, a sulfate, a carbonate, an acetate or the like, which are readily soluble in water.

Preferable alkali earth metal salt used in the present invention is a magnesium salt because a change in pH of a solution upon addition of the magnesium salt is small. Any electrolyte magnesium salt may be used without particular limitation as long as it functions as an electrolyte. In terms of high solubility in water, magnesium chloride, magnesium bromide, magnesium iodide, magnesium sulfate and magnesium acetate are preferable. In terms of a small change in pH of a solution and easiness of treating the sediment of the abrasive and the waste liquid, magnesium chloride and magnesium sulfate are particularly preferable.

<Method for Adding Inorganic Salt>

A method for adding the inorganic salt to the abrasive-containing slurry (mother liquid) will now be described.

a) Concentration of Inorganic Salt

The inorganic salt may be directly added to the abrasive-containing slurry (mother liquid), or may be dissolved in a solvent such as water and then added to the abrasive-containing slurry (mother liquid). It is preferable that the inorganic salt is dissolved in a solvent and then added to the abrasive-containing slurry to obtain a homogeneous state in the slurry after the addition.

The concentration of the inorganic salt is preferably 0.5 to 50% by mass in an aqueous solution. To suppress a change in pH of the system and achieve more efficient separation of the abrasive from the glass component, the concentration is preferably 10 to 40% by mass.

b) Temperature in Adding Inorganic Salt

The temperature when the inorganic salt is added may be in the range from the freezing temperature of the collected abrasive-containing slurry to 90° C. To efficiently separate the glass component, the temperature is preferably 10 to 40° C., and more preferably 15 to 35° C.

c) Speed of Adding Inorganic Salt

Speed of adding the inorganic salt to the abrasive-containing slurry (mother liquid) is preferably adjusted so that a portion with the high concentration in the collected abrasive-containing slurry is not generated and the added inorganic salt is homogeneously present in the collected abrasive-containing slurry. The amount of the added magnesium salt per minute is preferably 20% by mass or less, more preferably 10% by mass or less, per the total amount of the inorganic salt to be added.

d) pH Value after Addition of Inorganic Salt

In the method of the present invention for regenerating an abrasive, it is preferable that pH of the collected abrasive-containing slurry is not adjusted in advance when the inorganic salt is added in the separating and concentrating step B. Generally, the collected abrasive-containing slurry exhibits alkalinity and its pH ranges from 8 to less than 10 because of the presence of the glass component. In the present invention, it is preferable that the separating and concentrating are conducted while pH of the mother liquid converted for 25° C. condition is less than 10.0. This is because, when pH is 10 or more, a glass component, which is the polished object 3, tends to aggregate so that the glass component is aggregated together with an abrasive and sedimentation occurs. On the other hand, when pH is less than 10, difference in solubility is so large that a glass component is unlikely to be introduced into an abrasive component which is aggregated in the state of secondary particles.

In the present invention, the pH is obtained from the measurement at 25° C. using the Lacombe tester bench pH meter (pH1500, manufactured by AS ONE CORPORATION).

In the present invention, it is preferable that the pH is maintained to be equal to or less than the pH after the addition of the inorganic salt, upon the addition of the inorganic salt to the separation of the concentrate. In the present invention, the pH after the addition of the inorganic salt is the pH right after the end of adding the inorganic salt.

Accordingly, until the end of separating the aggregate, the pH is preferably maintained to be equal to or less than the pH after the addition of the inorganic salt. Specifically, the pH is preferably maintained less than 10.

e) Stirring after Addition of Inorganic Salt

After the addition of the inorganic salt, the stirring is continued for preferably 10 minutes or more, and more preferably 30 minutes or more. Upon the addition of the inorganic salt, the aggregation of the abrasive particles starts. The continuous stirring makes the aggregation state homogeneous in the system and reduces the particle size distribution, which makes the subsequent separation easy.

(3: Abrasive Collecting Step C)

In the abrasive collecting step C, solid-liquid separation of an abrasive is performed, the abrasive having been separated and concentrated in the separating and concentrating step B.

As the method for separating a concentrate of an abrasive aggregate obtained by addition of an inorganic salt from a supernatant, a common solid-liquid separation method can be used. For example, spontaneous sedimentation can be utilized for separating only the supernatant. A forcible method utilizing mechanical actions such as a method using a centrifugal separator can also be employable. As a concentration method for the present invention, a method utilizing spontaneous sedimentation is preferable to prevent the concentrate settled on the bottom from being contaminated with impurities, such as a glass component from the polished object 3, and to obtain a regenerated abrasive with high purity.

After addition of the organic salt, the collected abrasive particles aggregate while being separated from the supernatant. The specific weight of the concentrate is higher than that of the abrasive-containing slurry collected in the collecting step A, which means that it is concentrated. The concentration of the used abrasive in the concentrate is higher than that of the collected abrasive-containing slurry.

(4: Second Concentrating Step F)

In the second concentrating step F, the concentrate including the used abrasive is separated from the abrasive-containing slurry collected in the collecting step D. In separation of the second concentrating step F, separation by spontaneous sedimentation is applied to avoid contamination with impurities. Since a part of the supernatant is mixed with this concentrate without being separated or removed, in the second concentrating step F, the supernatant mixed with the concentrate is removed through filtration so that the purity of the collected used abrasive is further increased. This filtration can be done before the separating and concentrating step B. However, in view of productivity, the second concentrating step F is preferably conducted after a certain amount of glass component, etc. is removed in the separating and concentrating step B and in the abrasive collecting step C to avoid clogging with the glass component in the collected slurry. Although it is preferable to conduct the second concentrating step F for obtaining a higher-purity regenerated abrasive, it can be omitted according to the kind of an abrasive to be regenerated, required concentration, etc.

The filter used in the secondary concentrating step F is not particularly limited. Examples include hollow fiber filters, metal filters, wind filters, ceramic filters and roll-type polypropylene filters. Among them, ceramic filters are preferable for the present invention.

Examples of ceramic filters employable in the present invention include ceramic filters manufactured by TAMI Industries (France), ceramic filters manufactured by NORITAKE CO., LIMITED and ceramic filters manufactured by NGK INSULATORS, LTD. (e.g., CERALLEC DPF and Cefilt).

(5: Filtering Step D)

The method of the present invention for regenerating an abrasive includes the filtering step D after the second concentrating step F. In the filtering step D, metal particles included in the used abrasive-containing slurry, that is, metal particles that comes from operations in steps, devices, etc., such as metal particles that comes from alkali earth metal salt added in the separating and concentrating step B, are removed through filtration with a magnetic filter.

A magnetic filter used in the filtering step D is provided with a filter part made of a material such as a permanent magnet or an electromagnet. When the liquid of a concentrate, etc. including an abrasive passes through a filter made of a permanent magnet, an electromagnet, etc., metal particles, which is the purities described above, are drawn by a magnetic force of the filter to be removed from the abrasive. If an electromagnet is used as a material of the magnetic filter, a magnetic force is easily controlled by turning on/off electricity.

A specific form of the magnetic filter is not limited. For example, the magnetic filter has a bar shape along a pass of solution containing an abrasive or of a concentrate, or has a bar shape along a direction orthogonal to the pass of solution or a concentrate. One or more bar-shaped magnetic filters may be formed in the pass. The pass of solution or a concentrate may include one or more portions having a larger diameter (pool portion) which may be provided with the bar-shaped magnetic filter. The shape of the magnetic filter can be modified according to the kind, viscosity, etc. of the used abrasive-containing slurry.

(6: Particle Size Adjusting Step E)

The method of the present invention for regenerating an abrasive may include the particle size adjusting step E as the final step in which the abrasive aggregating in a form of secondary particles is peptized to obtain a particle size distribution of primary particles so that the used abrasive collected through the above steps is made reusable.

The concentrate collected by using inorganic salt, etc. to aggregate abrasive particles is composed of lumps of secondary particles. Thus, for the purpose of the reuse, it is preferable to conduct the particle size adjusting step E at the end to cause re-dispersion through breaking the aggregate into pure particles (i.e., primary particles).

In the particle size adjusting step E, the aggregated abrasive component obtained in the filtering step D is re-dispersed to adjust the particle size such that the particle size distribution becomes equivalent to that in the un-treated abrasive-containing slurry.

Examples of the method for re-dispersing the aggregated abrasive particles include the following: a) water is added to lower the concentration of the inorganic ion in the solution; b) a metal-separating agent (or a dispersing agent) is added to lower the concentration of the metal ion on the abrasive; and c) the aggregated abrasive particles are cracked using a dispersing device or the like.

One of these methods can be used alone, or two or more of them may be used in combination. Preferably, any two of the methods a), b) and c) are used in combination. More preferably, all of the methods a), b) and c) are used in combination.

In the case of adding water, the amount of water to be added is adjusted based on the volume of the concentrated slurry. Generally, the amount of water is 5 to 50% by volume of the concentrated slurry, and preferably 10 to 40% by volume of the concentrated slurry.

Preferable examples of the metal-separating agent (dispersing agent) include agents composed of a poly-carboxylic acid-based polymer including a carboxyl group. An acrylic acid-maleic acid copolymer is particularly preferable. Specifically, POLITY A-550 (manufactured by Lion Corporation) is given as an example. The amount of the metal-separating agent (dispersing agent) to be added to the concentrated slurry is preferably 0.01 to 5% by volume.

Examples of the dispersing device include ultrasonic dispersers and media mills such as sand mills and bead mills. Ultrasonic dispersers are particularly preferable.

For example, an ultrasonic disperser is available from SMT Corporation, Ginsen Corporation, TAITEC Corporation, BRANSON, Kinematica AG, and NISSEI Corporation. Examples include UDU-1 and UH-600MC manufactured by SMT Corporation, GSD600CVP manufactured by Ginsen Corporation and RUS600TCVP manufactured by NISSEI Corporation. The frequency of ultrasonic is not particularly limited.

Examples of circulating type devices that conduct mechanical stirring and ultrasonic dispersion simultaneously include, but are not limited to, UDU-1 and UH-600MC manufactured by SMT Corporation, GSD600RCVP and GSD1200RCVP manufactured by Ginsen Corporation and RUS600TCVP manufactured by NISSEI Corporation.

Preferably, a change with time of the particle size distribution obtained in this particle size adjusting step E is small, and a change in the particle size after one day has passed is small.

[Regenerated Abrasive]

The collected abrasive obtained after the particle size adjusting step E as the final product includes an abrasive with high purity that is more than 98% by mass. The change in the particle size distribution with time is small. The concentration is higher than that after the collection. The content of inorganic salt preferably ranges from 0.0005 to 0.08% by mass.

In the method for regenerating an abrasive, the filtering step D may be conducted anytime after the slurry collecting step A. For example, the filtering step D may be conducted after the separating and concentrating step B, the abrasive collecting step C or the second concentrating step D. Alternatively, the filtering step D may be conducted simultaneously with these steps. If the method includes the particle size adjusting step E, since this step E is the final step of the method for regenerating an abrasive where re-dispersion is caused to turn abrasive particles that are lumps of secondary particles into pure particles (primary particles), the filtration of the filtering step D is preferably performed before the particle size adjusting step E where all of the metal particles that comes from operations, etc. in the steps are removed.

### EXAMPLES

The present invention will now be described in detail with reference to Examples, but the present invention is not limited thereto. The percent sign “%” in the following description means “% by mass” unless described otherwise.

### Preparation of Regenerated Abrasive

### Preparation of Regenerated. Abrasive 1

### Example 1

A regenerated abrasive 1 was prepared through the following steps. Cerium oxide was used as an abrasive. Regeneration of an abrasive was conducted at 25° C. and 55% RH unless described otherwise. In the regeneration, the temperature of the solution was also 25° C.

1) Slurry Collecting Step A

After a glass substrate for a hard disc was polished as a polishing process illustrated in FIG. 1 using cerium oxide (manufactured by C. I. Kasei Company, Limited), 210 liters of the rinse slurry containing the washing water and 30 liters of the life-ended slurry containing a used abrasive were collected to obtain 240 liters of the collected slurry liquid. The specific weight of this collected slurry liquid was 1.03, and the collected slurry liquid contained 8.5 kg of cerium oxide.

2) Separating and Concentrating Step B

2.0 liters of 10% aqueous solution by mass of magnesium chloride as an inorganic salt was added spending 10 minutes while the collected slurry was stirred so as to avoid sedimentation of the cerium oxide. pH converted for 25° C. condition just after addition of magnesium chloride was 8.60.

3) Abrasive Collecting Step C

The above stirring was continued for 30 minutes, and then the resulting slurry was left to stand for 45 minutes to separate the concentrate and let it settle out from the supernatant utilizing spontaneous sedimentation. After 45 minutes had passed, the supernatant was discharged using the discharging pump, and solid-liquid separation was performed to collect the concentrate. The volume of the collected concentrate was 60 liters.

4) Second Concentrating Step F

In the second concentrating step F, processing was performed through a filtration process with a filtration device which is not shown in drawings.

The concentrate collected in the above 3) Abrasive Collecting Step D in the state of secondary particles is transferred to the filtration device by a pump while being slowly stirred by a stirrer. This filtration device is provided with a filter. The concentrate is passed through the filter to separate a supernatant including a glass component. The separated supernatant is discharged to the outside of the system through a pipe. In the filtration, the concentrate was circulated through the filtration device at a flow rate of 1.2 L/min for 15 minutes until the volume of the concentrate at the start of the filtration decreased by half.

As the filter used in the secondary concentrating step, a ceramic filter “Cefilt” (pore size: 0.5 μm) manufactured by NGK INSULATORS, LTD. was used.

5) Filtering Step D

In the filtering step D, metal particles that get mixed in with the abrasive is removed by filtration with the magnetic filter.

Specifically, in filtration of the filtering step D, the magnetic force of the magnetic filter is 3000 tesla and the velocity of liquid transfer of the concentrate to be filtered is 0.5 L/min.

6) Particle Size Adjusting Step E

To the separated concentrate, 12 liters of water was added. In addition, 300 g of POLITY A-550 (Manufactured by Lion Corporation) was added as a metal-separating agent (dispersing agent composed of a polymer) to the separated concentrate, followed by stirring for 30 minutes. Thereafter, the concentrate was broken and dispersed using an ultrasonic disperser (BRANSON).

After the dispersion was completed, filtration was conducted using a membrane filter with a pore size of 10 μm to obtain the regenerated cerium oxide-containing abrasive 1.

### Preparation of Regenerated Abrasive 2

### Example 2

A regenerated abrasive 2 was prepared in the same way as the regenerated abrasive 1 was prepared except that the velocity of liquid transfer in the filtering step D was changed to 1.0 L/min.

### Preparation of Regenerated Abrasive 3

### Example 3

A regenerated abrasive 3 was prepared in the same way as the regenerated abrasive 1 was prepared except that the velocity of liquid transfer in the filtering step D was changed to 2.0 L/min.

### Preparation of Regenerated Abrasive 4

### Example 4

A regenerated abrasive 4 was prepared in the same way as the regenerated abrasive 1 was prepared except that the magnetic force of the magnetic filter in the filtering step D was changed to 5000 tesla.

### Preparation of Regenerated Abrasive 5

### Example 5

A regenerated abrasive 5 was prepared in the same way as the regenerated abrasive 2 was prepared except that the magnetic force of the magnetic filter in the filtering step D was changed to 5000 tesla.

### Preparation of Regenerated Abrasive 6

### Example 6

A regenerated abrasive 6 was prepared in the same way as the regenerated abrasive 3 was prepared except that the magnetic force of the magnetic filter in the filtering step D was changed to 5000 tesla.

### Preparation of Regenerated Abrasive 7

### Example 7

A regenerated abrasive 7 was prepared in the same way as the regenerated abrasive 2 was prepared except that the magnetic force of the magnetic filter in the filtering step D was changed to 10000 tesla.

### Preparation of Regenerated Abrasive 8

### Example 8

A regenerated abrasive 8 was prepared in the same way as the regenerated abrasive 3 was prepared except that the magnetic force of the magnetic filter in the filtering step D was changed to 10000 tesla.

### Preparation of Regenerated Abrasive 9

### Example 9

A regenerated abrasive 9 was prepared in the same way as the regenerated abrasive 1 was prepared except that the magnetic force of the magnetic filter in the filtering step D was changed to 20000 tesla.

### Preparation of Regenerated Abrasive 10

### Example 10

A regenerated abrasive 10 was prepared in the same way as the regenerated abrasive 2 was prepared except that the magnetic force of the magnetic filter is changed to 20000 tesla in the filtering step D.

### Preparation of Regenerated Abrasive 11

### Comparative Example 1

A regenerated abrasive 11 was prepared in the same way as the regenerated abrasive 2 was prepared except that filtration of the filtering step D was not performed.

<<Evaluation of Regenerated Abrasive>>

### [Polishing Scratch]

The number of scratches no less than 0.2 μm on a doughnut-shaped glass substrate which is the polished object 3 and which has an outer diameter of 65 mm and an inner diameter of 20 mm was counted for Examples 1 to 10 and for Comparative Example 1.

Results from the above evaluation are shown in Table 1.

TABLE 1

| | | | Velocity | |
|---|---|---|---|---|
| | | Magnetic | of | Scratches |
| | Example/ | Force of | Liquid | After |
| Regenerated | Comparative | Filter | Transfer | Polishing |
| Abrasive | Example | (tesla) | (L/min) | (number) |
| 1 | Example 1 | 3000 | 0.5 | 9 |
| 2 | Example 2 | 3000 | 1.0 | 18 |
| 3 | Example 3 | 3000 | 2.0 | 27 |
| 4 | Example 4 | 5000 | 0.5 | 8 |
| 5 | Example 5 | 5000 | 1.0 | 15 |
| 6 | Example 6 | 5000 | 2.0 | 27 |
| 7 | Example 7 | 10000 | 1.0 | 12 |
| 8 | Example 8 | 10000 | 2.0 | 17 |
| 9 | Example 9 | 20000 | 0.5 | 6 |
| 10 | Example 10 | 20000 | 1.0 | 8 |
| 11 | Comparative | — | 1.0 | 51 |
| | Example 1 | | | |

As evident from the results shown in Table 1, the number of scratches after polishing in each of Examples 1 to 10 is apparently smaller than that in Comparative Example 1 in which processing with the magnetic filter in the filtering step D was not performed. Concerning Examples 1 to 10, it is supposed that, as the velocity of liquid transfer increases, a few metal particles remains in the abrasive and the number of scratches increases. It is known from Examples 1 to 10 that, as the magnetic force of the magnetic filter increases, the number of scratches after polishing decreases as compared with examples of the same velocity of liquid transfer.

As described above, according to the method of the embodiment for regenerating an abrasive, the abrasive is at least one selected from a group consisting of cerium oxide, diamond, boron nitride, silicon carbide, alumina, alumina-zirconia and zirconium oxide. The abrasive is regenerated from the used abrasive-containing slurry through: (A) collecting the abrasive-containing slurry including the used abrasive; (B) separating the abrasive from a mother liquid and concentrating the abrasive by adding a metal salt including an alkali earth metal as an inorganic salt to the collected abrasive-containing slurry to aggregate the abrasive; and (C) collecting the abrasive, which was separated and concentrated, through solid-liquid separation, (n) filtering metal particles that get mixed in with the abrasive-containing slurry using a magnetic filter to remove the particles. The step (D) is conducted after any one of the steps (A) to (C) or simultaneously with the step (B) or (C). Thereby impurities, such as metal particles that get mixed in through polishing of an object to be polished or metal particles that come from used devices or the like, are removed. Even a metal particle that has a smaller diameter than a particle of an abrasive is removed. Accordingly, a regenerated abrasive with higher purity is obtained from the used abrasive-containing slurry.

Since the magnetic filter is constituted by a permanent magnet material or an electromagnet material, metal particles are removed no matter how large the particles of an abrasive are. When an electromagnet is used, a magnetic force is easily controlled by turning on/off electricity.

The method further includes (E) adjusting sizes of particles of the collected abrasive. Since the filtering step (D) is conducted just before the step (E) which is the final step, all of the metal particles that get mixed in through the steps are removed.

The method further includes (F) secondarily concentrating the collected abrasive through filtration, after the step (C) and before the step (E). Therefore, a regenerated abrasive with a higher concentration of an abrasive is obtained.

The metal salt including an alkali earth metal used in the step (B) is a magnesium salt. Therefore, the pH change of the solution through addition is small, and a precipitating abrasive and waste liquid can be easily processed.

In the step (C), the collecting is conducted through separation by decantation utilizing spontaneous sedimentation. Therefore, the precipitating abrasive is prevented from being contaminated with impurities such as a glass component from a polished object, and a regenerated abrasive with higher purity is obtained.

When an electromagnet is used as the magnetic filter, magnetic poles may be replaced with each other by changing the direction of a current in the electromagnet at predetermined intervals. Thereby drawn metal particles stick to the magnetic filter in a wide range.

The magnetic forces and the velocities of liquid transfer in the filtering step D are shown as examples and can be modified according to the kind, concentration, viscosity or the like of an abrasive. Although filtration of the filtering step D is performed once in the method of the invention for regenerating an abrasive, it may be performed for a plurality of times according to the kind or the like of an abrasive.

### INDUSTRIAL APPLICABILITY

The present invention can be used in the field of regenerating an abrasive used in a manufacture process of a glass product, a semiconductor device, a crystal oscillator, etc.

### DESCRIPTION OF REFERENCE SIGNS

1 Abrader
2 Abrasive surface plate
3 Polished object
4 Abrasive liquid
5 Slurry nozzle
7 Washing water
8 Washing water-spraying nozzle
10 Abrasive-containing wash liquid
F Filtration-concentration unit
K Abrasive cloth
T₁ Slurry tank
T₂ Washing water tank
T₃ Wash liquid tank

1. A method for regenerating an abrasive from an abrasive-containing slurry including a used abrasive, the method comprising:
(A) collecting the abrasive-containing slurry including the used abrasive;
(B) separating the abrasive from a mother liquid and concentrating the abrasive by adding a metal salt including an alkali earth metal as an inorganic salt to the collected abrasive-containing slurry to aggregate the abrasive; and
(C) collecting the abrasive, which was separated and concentrated, through solid-liquid separation,
(D) filtering metal particles that get mixed in with the abrasive-containing slurry using a magnetic filter to remove the particles,
wherein the step (D) is conducted after any one of the steps (A) to (C) or simultaneously with the step (B) or (C), and
wherein the abrasive is at least one selected from a group consisting of cerium oxide, diamond, boron nitride, silicon carbide, alumina, alumina-zirconia and zirconium oxide.

2. The method of claim 1, wherein
the magnetic filter is constituted by a permanent magnet material or an electromagnet material.

3. The method of claim 1, further comprising:
(E) adjusting sizes of particles of the collected abrasive,
wherein the step (D) is conducted just before the step (E).

4. The method of claim 3, further comprising:
(F) secondarily concentrating the collected abrasive through filtration, after the step (C) and before the step (E).

5. The method of claim 1, wherein
the metal salt including an alkali earth metal used in the step (B) is a magnesium salt.

6. The method of claim 1, wherein
in the step (C), the collecting is conducted through separation by decantation utilizing spontaneous sedimentation.
